(19) United States
(12) Patent Application Publication
(10) Pub. No.: US 2026/0264115 A1
(43) Pub. Date: Sep. 10, 2026

(54) ELECTRODE INSPECTION SYSTEM AND METHOD

(71) Applicant: SK ON CO., LTD., Seoul (KR)

(72) Inventors: Joon Ho BAE, Daejeon (KR); Seong Heon LEE, Daejeon (KR); Jae Geun JEON, Daejeon (KR); Song Hyeon KIM, Daejeon (KR); Sang Jun PARK, Daejeon (KR); Hyun Min KANG, Daejeon (KR); Jong Min GIM, Daejeon (KR)

(21) Appl. No.: 19/146,923

(22) PCT Filed: Jan. 10, 2024
(86) PCT No.: PCT/KR2024/000453

§ 371 Date: Jul. 10, 2025

(30) Foreign Application Priority Data
Jan. 20, 2023 (KR) 10-2023-0008711
Dec. 5, 2023 (KR) 10-2023-0174518

(51) Int. Cl. B07C 5/342

(52) U.S. Cl. CPC B07C 5/3422

(57) ABSTRACT

An electrode inspection system according to exemplary embodiments of the present disclosure is an electrode inspection system configured to inspect an electrode, which includes a transfer unit including a transfer body extending in a longitudinal direction and a transfer mover that is movably coupled to the transfer body and configured to load the electrode, a pickup unit including a pickup body extending in a transverse direction and a pickup mover that is movably coupled to the pickup body and configured to pick up the electrode from the transfer body and load it, a carrier configured to receive the electrode from the pickup mover and load the electrode, and an inspection unit configured to obtain an image of the electrode loaded on the carrier.

### CROSS-REFERENCE TO RELATED APPLICATIONS

This patent application is a national stage application of PCT/KR2024/000453 filed on Jan. 10, 2024, which claims the benefit of and priority to Korean patent application No. 10-2023-0008711, filed on Jan. 20, 2023, and Korean patent application No. 10-2023-0174518, filed on Dec. 5, 2023, the disclosures of which are incorporated herein by reference in their entirety.

### TECHNICAL FIELD

The present disclosure relates to an electrode inspection system and an electrode inspection method.

### BACKGROUND ART

If a foreign substance or burr is present on the surface of an electrode, it may be difficult to use the electrode in a battery or other applications. Therefore, an automatic inspection process for the electrode may be necessary during the electrode manufacturing process.

### SUMMARY

According to an aspect of the present disclosure, it is an embodiment to provide an electrode inspection system capable of performing different processes based on the results of the quality inspection of the electrode and an electrode inspection method.

An electrode inspection system according to exemplary embodiments of the present disclosure is an electrode inspection system configured to inspect an electrode, which may include: a transfer unit including a transfer body extending in a longitudinal direction and a transfer mover that is movably coupled to the transfer body and configured to load the electrode; a pickup unit including a pickup body extending in a transverse direction and a pickup mover that is movably coupled to the pickup body and configured to pick up the electrode from the transfer body and load it; a carrier configured to receive the electrode from the pickup mover and load the electrode; and an inspection unit configured to obtain an image of the electrode loaded on the carrier.

An electrode inspection method (S10) according to exemplary embodiments of the present disclosure is an electrode inspection method (S10) for inspecting an electrode, which may include the steps of: stopping (S100) a transfer mover configured to pick up and transfer the electrode; picking up (S200) the electrode from the transfer mover and loading it onto a carrier positioned at a first reference position; inspecting (S300) the electrode; determining (S400), by a controller, whether the quality of the electrode is acceptable; performing (S500), by the controller, a first process if the quality of the electrode is acceptable; and performing (S600), by the controller, a second process if the quality of the electrode is unacceptable.

The electrode inspection system and method according to an embodiment of the present disclosure may perform different processes based on the results of the quality inspection of the electrode.

The electrode inspection system of the present disclosure may be widely applied in green technology fields, such as electric vehicles, battery charging stations, as well as solar power generation, wind power generation, and the like, which use the batteries.

The electrode inspection system of the present disclosure may be used in eco-friendly electric vehicles, hybrid vehicles, and the like, which are aimed at mitigating climate change by reducing air pollution and greenhouse gas emissions.

### BRIEF DESCRIPTION OF DRAWINGS

FIG. 1 is a view illustrating a transfer unit according to an embodiment of the present disclosure.

FIG. 2 is a view illustrating a pickup unit according to an embodiment of the present disclosure.

FIG. 3 is a view illustrating a state in which an electrode is mounted on a carrier.

FIG. 4 is a view illustrating a state in which an inspection unit according to an embodiment of the present disclosure inspects the electrode.

FIG. 5 is a view illustrating a dump unit according to an embodiment of the present disclosure.

FIG. 6 is a flowchart illustrating an electrode inspection method according to an embodiment of the present disclosure.

FIG. 7 is a flowchart illustrating a step of inspecting the electrode of the present disclosure.

FIG. 8 is a flowchart illustrating a step of performing a first process according to an embodiment of the present disclosure.

FIG. 9 is a flowchart illustrating a step of performing a second process according to an embodiment of the present disclosure.

FIG. 10 is a flowchart illustrating a step of dumping the electrode in the second process according to an embodiment of the present disclosure.

### DETAILED DESCRIPTION

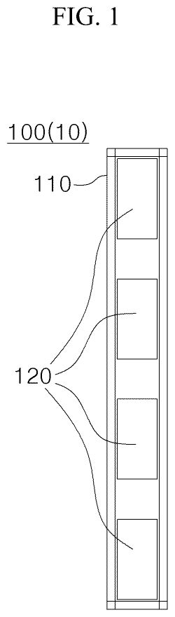

Hereinafter, the embodiments of the present disclosure will be described in detail with reference to FIGS. 1 to 10. However, these embodiments are merely examples, and the present disclosure is not limited to the specific embodiments described as example.

FIG. 1 is a view illustrating a transfer unit according to an embodiment of the present disclosure.

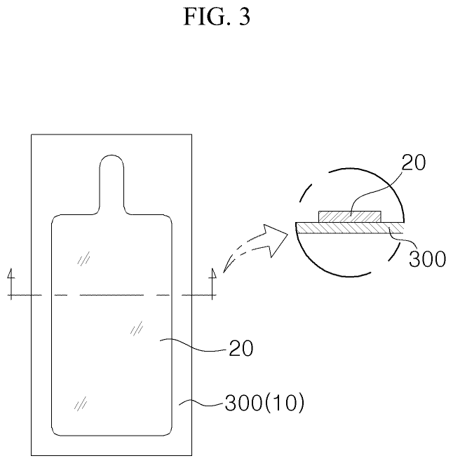

Referring to FIG. 1, an electrode inspection system 10 may include a transfer unit 100. The transfer unit 100 may be configured to transfer an electrode 20 (see FIG. 3) in one direction. For example, the transfer unit 100 may be configured to transfer the electrode 20 (see FIG. 3) in a longitudinal direction.

The transfer unit 100 may include a transfer body 110. The transfer body 110 may have a shape that extends in one direction. For example, the transfer body 110 may extend in the longitudinal direction. For example, the transfer body 110 may include a rail that extends in the longitudinal direction.

For example, the longitudinal direction of the electrode inspection system 10 may be a direction formed on a horizontal plane. For example, the lateral direction of the electrode inspection system 10 may be another direction formed on the horizontal plane and may intersect the longitudinal direction.

The transfer unit 100 may include a transfer mover 120. The transfer mover 120 may be connected or coupled to the transfer body 110. For example, the transfer mover 120 may be movably coupled to the transfer body 110.

For example, the transfer mover 120 may move longitudinally in the transfer body 110. For example, the transfer mover 120 may move along the transfer body 110 and may also stop.

For example, the transfer mover 120 may enter one end of the transfer body 110, move along the transfer body 110, and be discharged to the outside from the other end of the transfer body 110.

The transfer mover 120 may accommodate the electrode 20 (see FIG. 3).

The transfer mover 120 may include a magazine configured to accommodate a plurality of electrodes 20 (see FIG. 3).

The system may be provided with a plurality of transfer movers 120. For example, the plurality of transfer movers 120 may be arranged along the longitudinal direction.

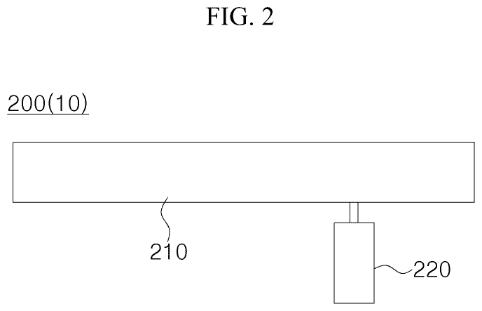

FIG. 2 is a view illustrating a pickup unit according to an embodiment of the present disclosure.

Referring to FIG. 2, the electrode inspection system 10 may include a pickup unit 200. The pickup unit 200 may pick up the electrode 20 (see FIG. 3) from the transfer unit 100 (see FIG. 1).

The pickup unit 200 may include a pickup body 210. The pickup body 210 may extend or be elongated in one direction. For example, the longitudinal direction of the pickup body 210 may intersect the longitudinal direction of the transfer body 110 (see FIG. 1).

For example, the pickup body 210 may extend or be elongated in a transverse direction. For example, the pickup body 210 may include a rail that extends or is elongated in the transverse direction.

The pickup body 210 may contact or intersect the transfer unit 100 (see FIG. 1). For example, the pickup body 210 may contact or intersect the transfer body 110 (see FIG. 1). For example, one end of the pickup body 210 may contact the transfer body 110 (see FIG. 1).

The pickup unit 200 may include a pickup mover 220. The pickup mover 220 may be connected or coupled to the pickup body 210. For example, the pickup mover 220 may be movably coupled to the pickup body 210. For example, the pickup mover 220 may move along the pickup body 210. For example, the pickup mover 220 may move in a transverse direction along the pickup body 210.

The pickup mover 220 may carry the electrode 20 (see FIG. 3) positioned on the transfer mover 120 (see FIG. 1). For example, the pickup mover 220 may move while carrying the electrode 20 (see FIG. 3). For example, the pickup mover 220 may move to a first reference position while carrying the electrode 20 (see FIG. 3).

For example, the pickup mover 220 may mount the carried electrode 20 (see FIG. 3) on a carrier 300 (see FIG. 3). For example, the pickup mover 220 may transfer the electrode 20 (see FIG. 3) to the carrier 300 (see FIG. 3) at the first reference position.

FIG. 3 is a view illustrating a state in which the electrode is mounted on the carrier.

Referring to FIG. 3, the electrode inspection system 10 may include the carrier 300. The carrier 300 may have an upper surface. The electrode 20 may be positioned on the upper surface of the carrier 300. The electrode 20 may be mounted on the upper surface of the carrier 300.

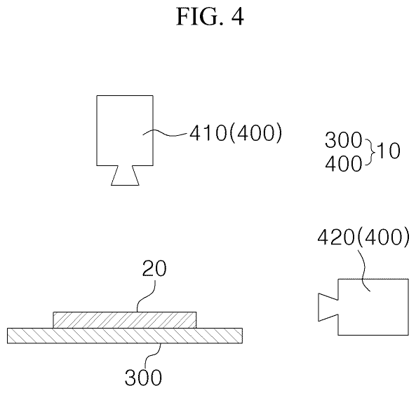

The carrier 300 may be movable. For example, the carrier 300 may receive the electrode 20 at the first reference position and move to a first inspection position. At the first inspection position, the electrode 20 mounted on the carrier 300 may be inspected by an inspection unit 400 (see FIG. 4). For example, one surface of the electrode 20 may be inspected.

For example, the carrier 300 may move from the first inspection position to a second inspection position. After the carrier 300 has moved to the second inspection position, the electrode 20 mounted on the carrier 300 may be flipped by a flip unit (not shown).

For example, the carrier 300 may move from the second inspection position to the first inspection position. The flipped electrode 20 may be inspected by the inspection unit 400 (see FIG. 4) at the first inspection position. For example, the other surface of the electrode 20 may be inspected.

For example, the carrier 300 may move from the first inspection position to the first reference position. If the electrode 20 mounted on the carrier 300 is determined to be acceptable, the carrier 300 may move from the first inspection position to the first reference position. At the first reference position, the pickup unit 200 (see FIG. 2) may transfer the electrode 20 mounted on the carrier 300 to the transfer unit 100 (see FIG. 1).

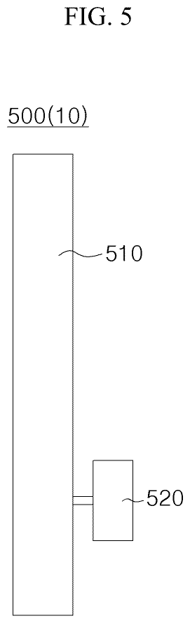

For example, the carrier 300 may move from the first inspection position to a first dump position. If the electrode 20 mounted on the carrier 300 is determined to be unacceptable, the carrier 300 may move from the first inspection position to the first dump position. At the first dump position, a dump unit 500 (see FIG. 5) may pick up and transfer the electrode 20 mounted on the carrier 300.

FIG. 4 is a view illustrating a state in which the inspection unit according to an embodiment of the present disclosure inspects the electrode.

Referring to FIG. 4, the electrode inspection system 10 may include the inspection unit 400. The inspection unit 400 may obtain an image of the electrode 20 mounted on the carrier 300.

For example, the electrode inspection system 10 may include a first inspection module 410. The first inspection module 410 may be positioned above the electrode 20 mounted on the carrier 300 that is positioned at the first inspection position.

The first inspection module 410 may obtain an image of one surface of the electrode 20. The first inspection module 410 may obtain an image of a perimeter of the electrode 20. For example, the first inspection module 410 may obtain an image of a bur when a bur is formed protruding from the perimeter of the electrode 20.

For example, the electrode inspection system 10 may include a second inspection module 420. The second inspection module 420 may be positioned adjacent to the electrode 20 mounted on the carrier 300 that is positioned at the first inspection position.

The second inspection module 420 may obtain an image of a foreign substance or the like protruding from or present on one surface of the electrode 20.

For example, the second inspection module 420 may obtain an image of a foreign substance or the like protruding from or present on an upper surface of the electrode 20.

The inspection unit 400 may include or refer to at least one of the first inspection module 410 and the second inspection module 420. The inspection unit 400 may be movable. For example, the first inspection module 410 may move along the perimeter of the electrode 20. For example, the second inspection module 420 may move along the perimeter of the carrier 300 in a looped path.

In another example, while the position of the inspection unit 400 is fixed and the carrier 300 moves, an image of the electrode 20 mounted on the carrier 300 may be obtained. For example, the carrier 300 may move horizontally or rotate about the first inspection position.

FIG. 5 is a view illustrating the dump unit according to an embodiment of the present disclosure.

Referring to FIG. 5, the electrode inspection system 10 may include the dump unit 500. The dump unit 500 may pick up and dump the electrode 20 (see FIG. 4) loaded on the carrier 300 (see FIG. 4). In terms of picking up the electrode 20 (see FIG. 4), the structure and function of the dump unit 500 may be respectively similar to those of the pickup unit 200 (see FIG. 2).

The dump unit 500 may include a dump body 510. The dump body 510 may extend or be elongated in one direction. The dump body 510 may extend or be elongated in the longitudinal direction, for example. The dump body 510 may include a rail.

The dump unit 500 may include a dump mover 520. The dump mover 520 may be movably coupled to the dump body 510. For example, the dump mover 520 may move along the dump body 510.

For example, the dump mover 520 may pick up the electrode 20 (see FIG. 4) from the carrier 300 (see FIG. 4) at the first dump position. The dump mover 520 may move from the first dump position to a second dump position.

For example, the dump mover 520 may dump the carried electrode 20 (see FIG. 4) at the second dump position. The dump mover 520, after dumping the electrode 20 (see FIG. 4), may move from the second dump position to the first dump position.

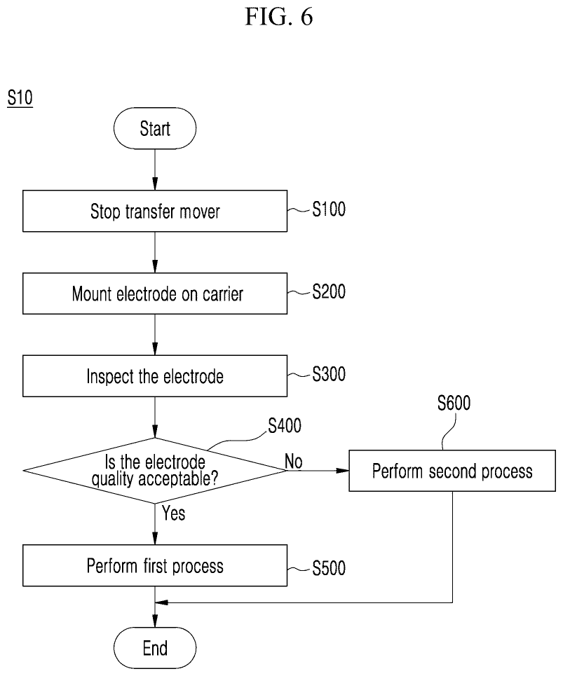

FIG. 6 is a flowchart illustrating an electrode inspection method according to an embodiment of the present disclosure.

Referring to FIGS. 1 to 6, the electrode inspection method (S10) may include a step (S100) of stopping the transfer mover 120. In step S100, the transfer mover 120 may stop while moving along the transfer body 110.

The electrode inspection method (S10) may include a step (S200) of mounting the electrode 20 on the carrier 300. In step S200, the pickup unit 200 may pick up and carry the electrode 20 positioned on the transfer mover 120.

The electrode inspection method (S10) may include a step (S300) of inspecting the electrode 20. The electrode 20 mounted on the carrier 300 may be inspected at the first inspection position. In step S300, the inspection unit 400 may inspect the electrode 20. For example, in step S300, the inspection unit 400 may obtain an image of the electrode 20.

The pickup mover 220 may pick up and transfer the electrode 20 from the first reference position to the first inspection position. For example, in either step (S200) of mounting the electrode 20 on the carrier 300 or step (S300) of inspecting the electrode, the pickup mover 220 may move from the first reference position to the first inspection position while carrying the electrode 20.

The electrode inspection method (S10) may include a step (S400) of determining whether the quality of the electrode 20 is acceptable. In step S400, the inspection unit 400 or a controller (not shown) may read the image obtained by the inspection unit 400 to determine whether the quality of the electrode 20 is acceptable.

The electrode inspection method (S10) may include a step (S500) of performing a first process. If the quality of the electrode 20 is determined to be acceptable, the electrode inspection system 10 may perform step S500. In step S500, the electrode 20 may be transferred to the transfer mover 120.

The electrode inspection method (S10) may include a step (S600) of performing a second process. If the quality of the electrode 20 is determined to be unacceptable, the electrode inspection system 10 may perform step S600.

In step S600, the electrode 20 may be transferred to the dump mover 520 and dumped. In step S600, a process of inspecting the notching of the electrode 20 may be performed.

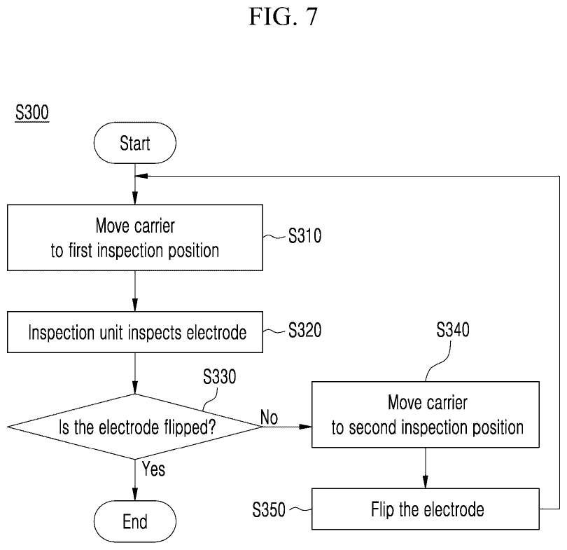

FIG. 7 is a flowchart illustrating the step of inspecting the electrode of the present disclosure.

Referring to FIGS. 1 to 7, the step (S300) of inspecting the electrode may include a step (S310) of moving the carrier 300 to the first inspection position. In step S310, the carrier 300 may move from the first reference position to the first inspection position.

The step (S300) of inspecting the electrode may include a step (S320) of inspecting the electrode 20 by the inspection unit 400. In step S320, the inspection unit 400 may inspect the electrode 20 mounted on the carrier 300. For example, in step S320, the inspection unit 400 may obtain an image of the electrode 20.

The step (S300) of inspecting the electrode may include a step (S330) of determining whether the electrode 20 is flipped. In step S330, the controller (not shown) may determine whether the electrode 20 mounted on the carrier 300 has been flipped or is in a flipped state.

If the electrode 20 is determined to be in a flipped state, the controller (not shown) may terminate the step (S300) of inspecting the electrode. If the electrode 20 is determined to be not in a flipped state, the controller (not shown) may perform a subsequent step (S340).

The step (S300) of inspecting the electrode may include a step (S340) of moving the carrier 300 to the second inspection position. If the electrode 20 is determined to be not in a flipped state, the controller may perform step S340. In step S340, the carrier 300 loaded with the electrode 20 may move to the second inspection position.

The step (S300) of inspecting the electrode may include a step (S350) of flipping the electrode 20. In step S350, the flip unit (not shown) may pick up the electrode 20 mounted on the carrier 300, flip it over, and then load the electrode 20 in the flipped state onto the carrier 300. After the step (S350) of flipping the electrode 20, a step (S310) of moving the carrier 300 to the first inspection position may be performed.

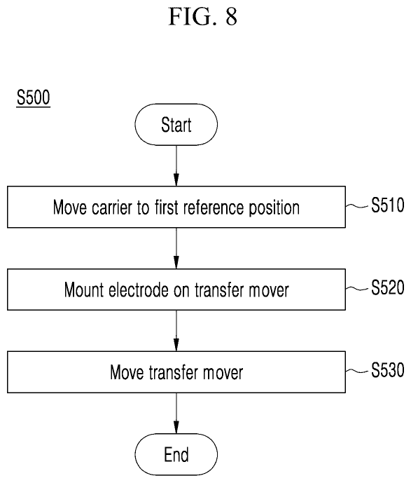

FIG. 8 is a flowchart illustrating the step of performing a first process according to an embodiment of the present disclosure.

Referring to FIGS. 1 to 8, the step (S500) of performing a first process may include a step (S510) of moving the carrier 300 to the first reference position. In step S510, the controller (not shown) may move the carrier 300 to the first reference position.

The step (S500) of performing a first process may include a step (S520) of mounting the electrode 20 on the transfer mover 120. In step S520, the pickup mover 220 may pick up the electrode 20 mounted on the carrier 300 located at the first reference position, transfer the electrode, and mount it on the transfer mover 120.

The step (S500) of performing a first process may include a step (S530) of moving the transfer mover 120. In step S530, the transfer mover 120 may move while carrying the electrode 20. For example, in step S530, the transfer mover 120 may move toward the other end of the transfer body 110.

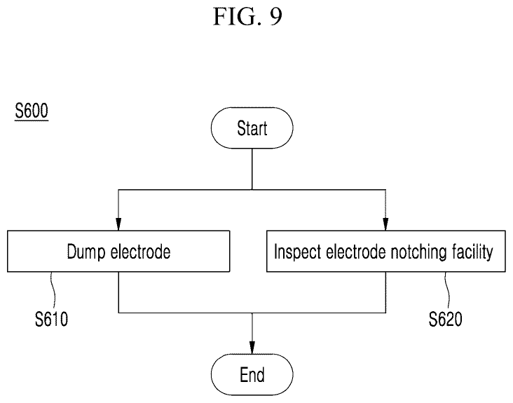

FIG. 9 is a flow chart illustrating the step of performing a second process according to an embodiment of the present disclosure.

Referring to FIGS. 1 to 9, the step (S600) of performing a second process may include a step (S610) of dumping the electrode 20. In step S610, the dump unit 500 may pick up and dump the electrode 20 mounted on the carrier 300.

The step (S600) of performing a second process may include a step (S620) of inspecting an electrode notching facility. The step (S620) of inspecting the electrode notching facility may be performed in parallel with the step (S610) of dumping the electrode 20. The electrode notching facility may notch an electrode sheet to fabricate the electrode 20.

For example, the step (S610) of dumping the electrode 20 and the step (S620) of inspecting the electrode notching facility may be performed in parallel. In another example, after the step (S620) of inspecting the electrode notching facility is completed, the step (S610) of dumping the electrode 20 may be performed.

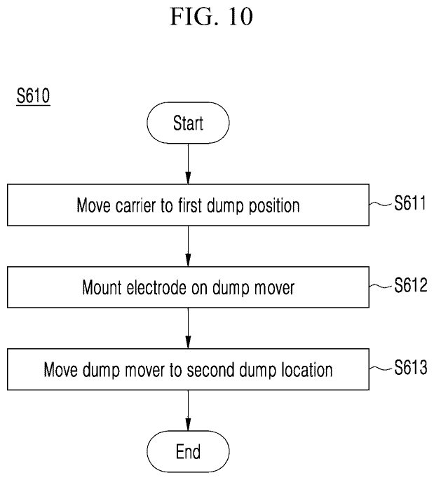

FIG. 10 is a flowchart illustrating the step of dumping the electrode in the second process according to an embodiment of the present disclosure.

Referring to FIGS. 1 to 10, the step (S610) of dumping the electrode 20 may include a step (S611) of moving the carrier 300 to the first dump position. In step S611, the controller (not shown) may move the carrier 300 from the first inspection position to the first dump position.

The step (S610) of dumping the electrode 20 may include a step (S612) of mounting the electrode 20 onto the dump mover 520. In step S612, the dump mover 520 may pick up the electrode 20. In step S612, the electrode 20 may be moved from the carrier 300 to the dump mover 520.

The step (S610) of dumping the electrode 20 may include a step (S613) of moving the dump mover 520 to the second dump position. The dump mover 520 may move from the first dump position to the second dump position in step S613. In step S613, the dump mover 520 may dump the electrode 20 at the second dump position.

Thereafter, the dump mover 520 may move from the second dump position to the first dump position.

The contents described above are merely examples of applying the principles of the present disclosure, and other configurations may be further included without departing from the scope of the present disclosure.

What is claimed is

1. An electrode inspection system configured to inspect an electrode, comprising:
a transfer unit including a transfer body extending in a longitudinal direction and a transfer mover that is movably coupled to the transfer body and configured to load the electrode;
a pickup unit including a pickup body extending in a transverse direction and a pickup mover that is movably coupled to the pickup body and configured to pick up the electrode from the transfer body and load it;
a carrier configured to receive the electrode from the pickup mover and load the electrode; and
an inspection unit configured to obtain an image of the electrode loaded on the carrier.

2. The electrode inspection system according to claim 1, wherein the carrier receives the electrode from the pickup mover at a first reference position and moves to a first inspection position.

3. The electrode inspection system according to claim 2, wherein the inspection unit obtains the image of the electrode loaded on the carrier positioned at the first inspection position.

4. The electrode inspection system according to claim 1, wherein the electrode has one surface and the other surface formed to face each other, and
the other surface of the electrode faces and contacts an upper surface of the carrier.

5. The electrode inspection system according to claim 4, wherein the inspection unit comprises:
a first inspection module positioned above the carrier; and
a second inspection module positioned to face a side surface of the carrier.

6. The electrode inspection system according to claim 1, further comprising a flip unit configured to pick up the electrode from the carrier and load the electrode onto the carrier while the electrode is in a flipped state.

7. The electrode inspection system according to claim 6, wherein the carrier receives the electrode from the pickup mover at a first reference position and moves it to a first inspection position, and
the inspection unit obtains the image of the electrode loaded on the carrier positioned at the first inspection position.

8. The electrode inspection system according to claim 7, wherein the carrier moves from the first inspection position to a second inspection position while the electrode remains unflipped, and
the flip unit flips the electrode loaded on the carrier located at the second inspection position, and reloads the flipped electrode onto the carrier.

9. The electrode inspection system according to claim 8, wherein after the electrode is loaded onto the carrier in the flipped state, the carrier moves from the second inspection position to the first inspection position.

10. The electrode inspection system according to claim 1, further comprising a dump unit including a dump body extending in the longitudinal direction and a dump mover that is movably coupled to the dump body and configured to pick up the electrode loaded on the carrier.

11. The electrode inspection system according to claim 10, further comprising a controller configured to control the carrier, the dump unit, and the pickup unit,
wherein the carrier receives the electrode from the pickup mover at a first reference position and moves it to a first inspection position, and
the controller analyzes the image and, if the electrode is determined to be acceptable, moves the carrier from the first inspection position to the first reference position.

12. The electrode inspection system according to claim 11, wherein, if the electrode is determined to be unacceptable by analyzing the image, the controller moves the carrier from the first inspection position to the first dump position.

13. An electrode inspection method (S10) for inspecting an electrode, comprising the steps of:
stopping (S100) a transfer mover configured to pick up and transfer the electrode;
picking up (S200) the electrode from the transfer mover and loading it onto a carrier positioned at a first reference position;
inspecting (S300) the electrode;
determining (S400), by a controller, whether the quality of the electrode is acceptable;
performing (S500), by the controller, a first process if the quality of the electrode is acceptable; and
performing (S600), by the controller, a second process if the quality of the electrode is unacceptable.

14. The electrode inspection method (S10) according to claim 13, wherein the step of inspecting (S300) the electrode comprises:
moving (S310) the carrier to a first inspection position;
inspecting (S320), by an inspection unit, the electrode; and
determining (S330), by the controller, whether the electrode is flipped,
Wherein, if the electrode is determined to be flipped, the controller terminates the step of inspecting (S300) the electrode.

15. The electrode inspection method (S10) according to claim 14, wherein the step of inspecting (S300) the electrode comprises:
moving (S340), by the controller, the carrier to a second inspection position if the electrode is determined to be not in a flipped state; and,
flipping (S350), by a flip unit, the electrode loaded on the carrier located at the second inspection position.

16. The electrode inspection method (S10) according to claim 15, further comprising, after the flip step (S350), moving (S310), by the controller, the carrier to the first inspection position.

17. The electrode inspection method (S10) according to claim 13, wherein the step of performing (S500) a first process comprises:
moving (S510) the carrier to the first reference position;
mounting (S520) the electrode on the transfer mover; and
moving (S530) the transfer mover.

18. The electrode inspection method (S10) according to claim 13, wherein the step (S600) of performing a second process comprises:
dumping (S610) the electrode; and
inspecting (S620) an electrode notching facility configured to notch the electrode.

19. The electrode inspection method (S10) according to claim 18, wherein the step (S610) of dumping the electrode and the step (S620) of inspecting an electrode notching facility are performed in parallel.

20. The electrode inspection method (S10) according to claim 18, wherein the step (S610) of dumping the electrode comprises:
moving (S611) the carrier to a first dump position;
mounting (S612) the electrode loaded on the carrier on a dump mover; and
moving (S613) the dump mover to a second dump position.
